(19) United States
(12) Patent Application Publication
(10) Pub. No.: US 2026/0100439 A1
(43) Pub. Date: Apr. 9, 2026

(54) SECONDARY BATTERY

(71) Applicant: SAMSUNG SDI CO., LTD., Yongin-si (KR)

(72) Inventor: Dong Hyun KIM, Yongin-si (KR)

(21) Appl. No.: 19/193,470

(22) Filed: Apr. 29, 2025

(30) Foreign Application Priority Data
Oct. 4, 2024 (KR) 10-2024-0134597

(51) Int. Cl. H01M 10/6551; B60L 50/60; H01M 10/613; H01M 10/625; H01M 10/647; H01M 50/105; H01M 50/178; H01M 50/474

(52) U.S. Cl. CPC H01M 10/6551; H01M 10/613; H01M 10/625; H01M 10/647; H01M 50/105; H01M 50/178; H01M 50/474; B60L 50/60; H01M 2220/20

(57) ABSTRACT

A secondary battery includes a case comprising an accommodation part and a cap part, with an electrode assembly accommodated in the accommodation part. An electrode tab is connected to the electrode assembly, and a lead is connected to the electrode tab. An insulating layer is disposed to surround the lead, and a sealing layer seals the accommodation part and the cap part. The case comprises at least one layer in contact with the sealing layer. At least one of the accommodation part or the cap part comprises a heat dissipation member disposed on a surface of and inside of the at least one layer.

### CROSS-REFERENCE TO THE RELATED APPLICATION

The present application claims priority to and the benefit of Korean Patent Application No. 10-2024-0134597, filed on Oct. 4, 2024, in the Korean Intellectual Property Office, the entire disclosure of which is incorporated herein by reference.

### BACKGROUND

### 1. Field

Embodiments relate to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide a safer secondary battery having improved heat dissipation characteristics.

The secondary battery according to the embodiment includes a case comprising an accommodation part and a cap part, an electrode assembly accommodated in the accommodation part, an electrode tab connected to the electrode assembly, a lead connected to the electrode tab, an insulating layer surrounding the lead, and a sealing layer sealing the accommodation part and the cap part, the case comprises at least one layer in contact with the sealing layer, and at least one of the accommodation part or the cap part comprises a heat dissipation member disposed on a surface of and inside of the at least one layer.

The case comprises a first layer in contact with the sealing layer, a second layer on the first layer, and a third layer on the second layer, and at least one of the accommodation part or the cap part comprises the heat dissipation member disposed in one surface of and the inside of the first layer.

The case comprises a first sealing region and a second sealing region, and the lead and the insulating layer are disposed in the first sealing region.

The heat dissipation member is coupled to at least one of the accommodation part or the cap part.

The heat dissipation member is sewed to at least one of the accommodation part or the cap part.

The heat dissipation member comprises a first pattern and a second pattern, the first pattern is disposed on a surface of the first layer, and the second pattern is disposed in the first layer.

The first pattern and the second pattern are connected.

The first sealing region comprises a first region, a second region, and a third region, the lead, the insulating layer, and the sealing layer overlap in the first region, the insulating layer and the sealing layer overlap in the second region, the sealing layer is disposed in the third region, and the heat dissipation member is disposed in the first region, the second region, and the third region.

The heat dissipation member is disposed in a part of the third region.

The heat dissipation member comprises a plurality of linear parts extending in the same direction.

The lengths of the plurality of linear parts decrease in a direction away from a center of the linear parts.

The heat dissipation member comprises a plurality of linear parts extending in a plurality of directions.

The electrode assembly comprises a first electrode, a second electrode, and a separator between the first electrode and the second electrode, the electrode tab comprises a first electrode tab connected to the first electrode and a second electrode tab connected to the second electrode, the lead comprises a first lead connected to the first electrode tab and a second lead connected to the second electrode tab, and the heat dissipation member corresponds to at least one of the first lead or and the second lead.

The heat dissipation member comprises a first heat dissipation member corresponding to the first lead and a second heat dissipation member corresponding to the second lead, and the first heat dissipation member and the second heat dissipation member are different shapes.

At least one of the accommodation part or the cap part comprises a groove, the groove comprises a first groove and a second groove disposed in the first sealing region, the first lead is disposed in the first groove, and the second lead is disposed in the second groove.

The width of the groove is greater than a width of the lead.

The heat dissipation member is disposed in the groove.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view of a secondary battery according to an embodiment.

FIG. 2 is a top view of the secondary battery according to the embodiment.

FIG. 3 is an enlarged view of region A of FIG. 2.

FIG. 4 is a cross-sectional view of area A-A′ of FIG. 3.

FIG. 5 is a cross-sectional view of area B-B′ of FIG. 3.

FIGS. 6 and 7 are other cross-sectional views of area A-A′ of FIG. 3.

FIG. 8 is various enlarged views of region A of FIG. 3.

FIG. 9 is a top view of a case of the secondary battery according to another embodiment.

FIG. 10 is a top view of the secondary battery according to another embodiment.

FIGS. 11 and 12 are cross-sectional views of area C-C′ of FIG. 10.

FIGS. 13 and 14 are perspective views of a battery pack including battery modules according to some embodiments.

FIGS. 15 and 16 are perspective views and a side view of a vehicle including battery packs according to some embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, a secondary battery according to an embodiment will be described with reference to the drawings. The secondary battery may be classified as a cylindrical shape, a prismatic shape, a pouch shape, or a coin shape depending on its shape. The secondary battery described below may be configured as a pouch-type secondary battery, but the present disclosure is not limited thereto.

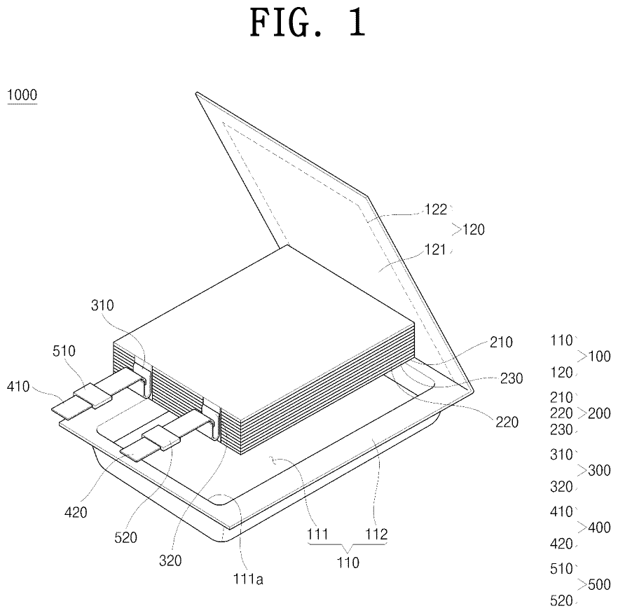

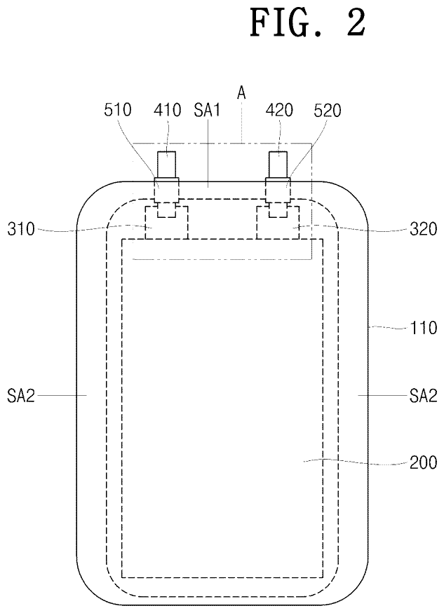

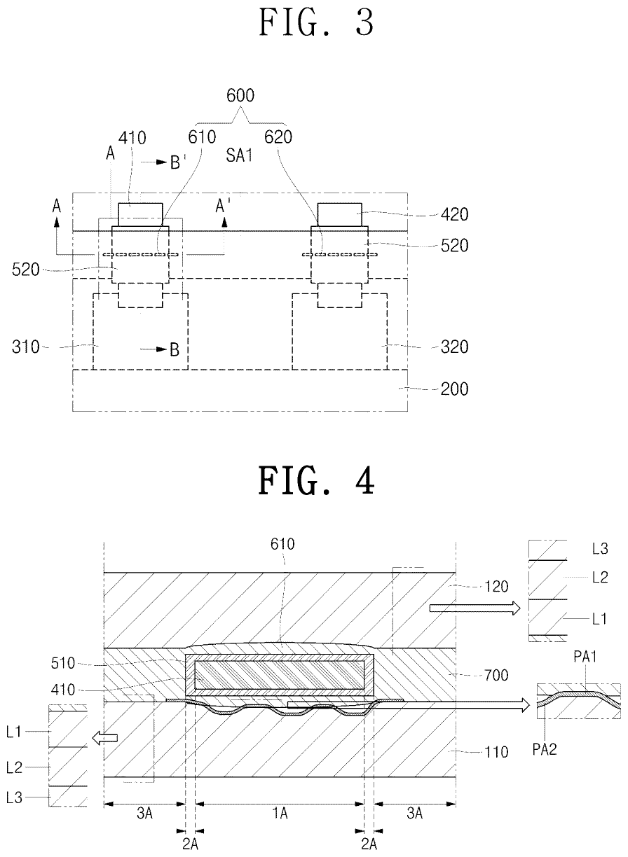

Referring to FIGS. 1 to 5, the secondary battery 1000 according to the embodiment may include a case 100 and an electrode assembly 200.

The case 100 may include an accommodation part 110 and a cap part 120. The accommodation part 110 and the cap part 120 may be connected. The case 100 may be formed in a pouch shape.

The accommodation part 110 may include a concave part 111 and a first sealing part 112. The accommodation part 110 may include an accommodation space. In detail, the accommodation part 110 may include an internal bottom surface and an inner side surface formed by the concave part 111. Thus, the accommodation space may be formed by the bottom surface and the inner side surface.

The first sealing part 112 may be disposed at the edge of the accommodation part 110. A sealing layer may be disposed on the first sealing part 112.

The cap part 120 may include a cover part 121 and a second sealing part 122. The cover part 121 may cover the accommodation part 110. In particular, the cover part 121 may cover the electrode assembly 200 accommodated in the accommodation part 110.

The second sealing part 122 may be disposed at the edge of the cap part 120, and the sealing layer may be disposed on the second sealing part 122. The first sealing part 112 and the second sealing part 122 may overlap. In detail, when the accommodation part 110 is covered by the cap part 120, the first sealing part 112 and the second sealing part 122 may face each other. Therefore, the accommodation part 110 and the cap part 120 may be coupled by the sealing layer.

The electrode assembly 200 may be accommodated inside the accommodation space of the case. In particular, the electrode assembly 200 may be accommodated inside the accommodation space together with the electrolyte.

In the drawings, one electrode assembly is accommodated in the case. However, the present disclosure is not limited thereto. Two or more electrode assemblies may be accommodated in the case.

The electrode assembly 200 may include a first electrode 210, a second electrode 220, and a separator 230. The electrode assembly 200 may be formed by winding or laminating the first electrode 210, the second electrode 220, and the separator 230. Alternatively, the electrode assembly may be a Z-stack electrode assembly in which the first electrode 210 and the second electrode 220 are inserted on both sides of a separator 230 and bent into a Z-stack.

The first electrode 210 may include a first current collector and a first active material layer formed on the first current collector. The first current collector may include a metal foil such as aluminum or an aluminum alloy. The first active material layer may include a transition metal oxide. In some embodiments, the first electrode 210 may be a positive electrode.

The first electrode 210 may be connected to a first electrode tab 310. The first active material layer is not disposed on the first electrode tab 310. The first electrode tab 310 may be welded to the first current collector. Alternatively, the first electrode tab 310 may be integrally formed with the first current collector. In some embodiments, the first collector may include a first uncoated portion on which the first active material layer is not disposed. The first uncoated portion may be the first electrode tab 310. The first electrode tab 310 may be formed from the same material as the first current collector.

The second electrode 220 may include a second current collector and a second active material layer formed on the second current collector. The second current collector may include a metal foil such as copper, a copper alloy, nickel, or a nickel alloy. The second active material layer may include graphite or carbon. In some embodiments, the second electrode 220 may be a negative electrode.

The second electrode 220 may be connected to a second electrode tab 320. The second active material layer is not disposed on the second electrode tab 320. The second electrode tab 320 may be welded to the second current collector. Alternatively, the second electrode tab 320 may be integrally formed with the second current collector. In some embodiments, the second collector may include a second uncoated portion on which the second active material layer is not disposed. The second uncoated portion may be the second electrode tab 320. The second electrode tab 320 may be formed from the same material as the second current collector.

The first electrode tab 310 and the second electrode tab 320 may each be connected to a lead. For example, the first electrode tab 310 may be connected to the first lead 410. The first electrode tab 310 may be connected to the first external terminal by the first lead 410. The second electrode tab 320 may be connected to the second lead 420. The second electrode tab 320 may be connected to the second external terminal by the second lead 420. The first lead 410 may be formed from the same material as the first electrode tab. And the second lead 420 may be formed from the same material as the second electrode tab.

An insulating layer 500 may be disposed on a portion of the lead. For example, the insulating layer may be disposed to surround the lead. In an embodiment, a first insulating layer 510 may be disposed on the first lead 410 and a second insulating layer 520 may be disposed on the second lead 420. The lead 400 may be insulated from the case 100 by the insulating layer 500. The first insulating layer 510 and the second insulating layer 520 may be disposed on a first sealing region SA1 (described below).

The case 100 may include the first sealing region SA1 and a second sealing region SA2. The first sealing region SA1 may be formed on a short side of the case 100, and the first sealing region SA1 may be a region where the lead 400 and the insulating layer 500 are disposed. The second sealing region SA2 may be formed on a long side of the case 100, and the second sealing region SA2 may be a region where the lead 400 is not disposed.

The case 100 may include a plurality of layers. For example, the case 100 may include a first layer L1, a second layer L2, and a third layer L3. The first layer L1 may be an inner layer of the case. The first layer L1 may protect the second layer L2 from contact with the electrolyte. The first layer L1 may be in contact with the sealing layer 700. In detail, the first layer L1 may be heat-sealed with the sealing layer 700. Accordingly, the first layer L1 may seal the accommodation part and the cap part 120. The first layer L1 and the sealing layer 700 may be fused to form a single sealing member. The sealing member may be fused with the insulating layer 500. Accordingly, the accommodation part 110 and the cap part 120 may be sealed. The first layer L1 may include a resin. In embodiments, the first layer L1 formed from the same material as at least one of the insulating layer 500 or the sealing layer 700. In a specific example, the first layer L1 may include polypropylene (PP).

The second layer L2 may be an intermediate layer of the case. The second layer L2 may prevent gas or moisture from penetrating into the interior of the case. The second layer L2 may include metal. For example, the second layer L2 may include aluminum (Al).

The third layer L3 may be an outer layer of the case and may constitute an outer surface of the secondary battery. The third layer L3 forming the outer layer of the case may prevent physical damage such as scratches. And the third layer L3 may serve as an insulating layer of the case. The third layer L3 may include a resin. For example, the third layer L3 may include at least one of nylon, polyethylene terephthalate (PET), or polyethylene naphthalate (PEN).

Dry lamination may be disposed in a region between the first layer L1 and the second layer L2 or a region between the second layer L2 and the third layer L3. The dry lamination may control the alignment of the layers.

The case 100 may include a heat dissipation member 600. For example, the heat dissipation member 600 may be disposed on at least one of the accommodation part 110 or the cap part 120. The heat dissipation member 600 also may be disposed on at least one of the first sealing region SA1 and the second sealing region SA2.

The heat dissipation member 600 may have a set thermal conductivity. For example, the thermal conductivity of the heat dissipation member 600 may be 0.02 W/mk to 0.04 W/mk. The heat dissipation member 600 may have a set melting point. For example, the melting point of the heat dissipation member 600 may be higher than the melting point of the separator. And the melting point of the heat dissipation member 600 may be higher than the melting point of the sealing layer 700. For example, the melting point of the heat dissipation member 600 may be 150° C. to 200° C.

The heat dissipation member 600 may include a first heat dissipation member 610 and a second heat dissipation member 620. The first heat dissipation member 610 may overlap the first lead 410 and the first insulating layer 510. The second heat dissipation member 620 may overlap the second lead 420 and the second insulating layer 520.

The heat dissipation member 600 may be coupled to the case 100. For example, the heat dissipation member may be sewed into the case 100. In detail, the heat dissipation member 600 may be sewed into the first layer L1.

Referring to FIGS. 4 to 7, the heat dissipation member is shown in detail. Hereinafter, the first heat dissipation member 610 will be mainly described. The description of the second heat dissipation member 620 is the same as that of the first heat dissipation member 610, and thus will be omitted.

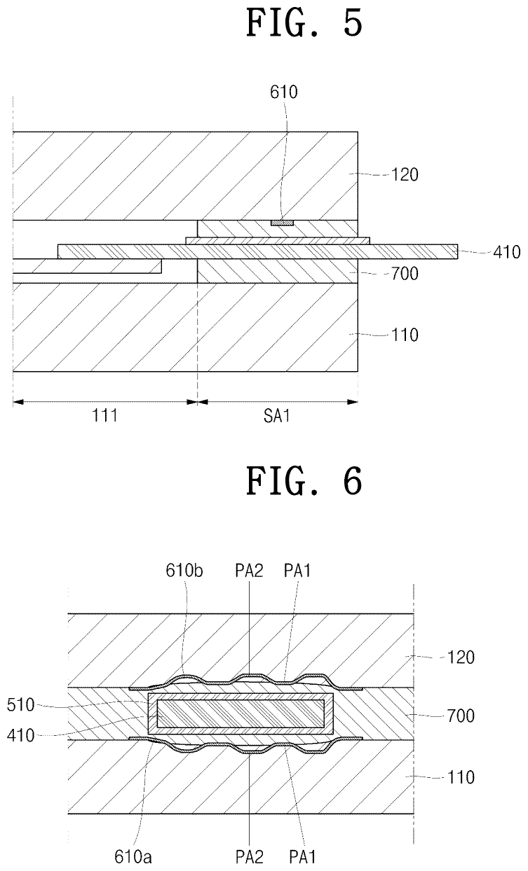

Referring to FIGS. 4 and 5, the first heat dissipation member 610 may be disposed in the accommodation part 110. More specifically, the first heat dissipation member 610 may be coupled with the accommodation part 110. The first heat dissipation member 610 may be screwed into one surface of the accommodation part 110. For example, the first heat dissipation member 610 may be sewed into the first layer L1. Accordingly, the first heat dissipation member 610 may be disposed outside and inside the first layer L1.

The first heat dissipation member 610 may include a first pattern PA1 and a second pattern PA2. The first pattern PA1 may be disposed on one surface of the first layer L1, and the second pattern PA2 may be disposed in the first layer L1. The first pattern PA1 and the second pattern PA2 may be connected. In detail, the first heat dissipation member 610 is formed by a sewing process. Thus, the first pattern PA1 and the second pattern PA2 may be formed integrally.

The first sealing region SA1 may be divided into a plurality of regions. For example, as shown in FIG. 4, the first sealing region SA1 may include a first region 1A, a second region 2A, and a third region 3A. The first region 1A may be a region where the lead 400, the insulating layer 500, and the sealing layer 700 overlap. The second region 2A may be a region where the insulating layer 500 and the sealing layer 700 overlap. And the third region 3A may be a region where only the sealing layer 700 is disposed.

The first heat dissipation member 610 may be disposed in at least one of the first region 1A, the second region 2A, or the third region 3A. For example, the first heat dissipation member 610 may be disposed on the first region 1A. In another example, the first heat dissipation member 610 may be disposed in the first region 1A and the second region 2A. In yet another example, the first heat dissipation member 610 may be disposed in the first region 1A, the second region 2A, and the third region 3A.

In embodiments, the first heat dissipation member 610 may be disposed in the first region 1A, the second region 2A, and the third region 3A. The first region 1A and the second region 2A may be entirely covered by the first heat dissipation member 610. The third region 3A may be partially covered by the first heat dissipation member 610.

The secondary battery may be exposed to a high temperature environment during storage or during its use. Accordingly, the electrolyte in the case may vaporize. Accordingly, high temperature and high-pressure gas may be generated in the case. When the secondary battery is exposed to a high temperature environment, the sealing members of the first region 1A and the second region 2A may remain sealed. Further, the sealing member of the third region 3A may be opened. Accordingly, when the temperature in the case is higher than the set temperature, the third region 3A may form a vent. The opening of the sealing member may mean that the sealing layer and the first layer are separated.

The first region and the second region are regions where the lead 400 and the insulating layer 500 are disposed. Accordingly, the thickness of the sealing layer in the first region 1A and the second region 2A is less than the thickness of the sealing layer in other regions. Accordingly, the bonding force between the sealing layer 700 of the first region 1A and the second region 2A and the first layer L1 may decrease. Thus, the sealing members of the first region 1A and the second region 2A ma open first by gas generated in the battery. That is, the sealing layers and the first layer of the first region 1A and the second region 2A may be easily separated. In such a case, the shape of the electrode assembly may be changed by the separation of the case. Accordingly, the separator may be contracted. Thus, the first electrode and the second electrode may be short-circuited causing a fire.

The embodiment may solve such a problem. The first layer includes a heat dissipation member on the first region and the second region. The heat dissipation member may block heat transfer to the sealing members of the first region and the second region. Accordingly, the temperature of the sealing member may not increase in the first region and the second region. Accordingly, the sealing layer and the first layer may not separate in the first region and the second region. Thus, a short circuit of the secondary battery may be prevented, and the safety and reliability of the secondary battery may be improved.

In addition, the heat dissipation member is disposed outside and inside of the first layer. That is, the heat dissipation member is formed on the first layer through the sewing process. Accordingly, the bonding characteristics of the heat dissipation member may be improved, and the heat dissipation member may be prevented from being separated by an external impact. And, since the heat dissipation member is sewed into the case, a separate space for disposing the heat dissipation layer is not required. Thus, the size of the case may not be increased by the heat dissipation member.

The heat dissipation member is disposed in a part of the third region. Accordingly, when the temperature and pressure in the case are out of a set range, the vent may be easily formed in the third region, and a fire of the secondary battery may be prevented.

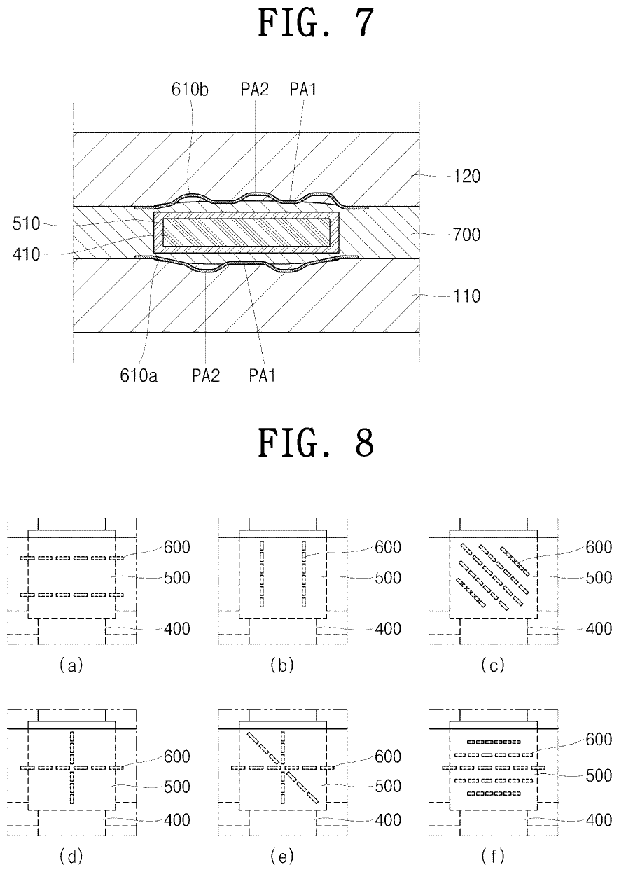

Referring to FIGS. 6 and 7, the first heat dissipation member may be disposed in the accommodation part 110 and the cap part 120. For example, the first heat dissipation member may include a 1a heat dissipation member 610a in the accommodation part 110 and a 1b heat dissipation member 610b in the cap part 120. The 1a heat dissipation member 610a may be sewed in the first layer of the accommodation part 110. The 1b heat dissipation member 610b may be sewed in the first layer of the cap part 120.

Therefore, the bonding force between the accommodation part 110 and the sealing layer 700 may be increased by the 1a heat dissipation member 610a. And the bonding force of the cap part 120 and the sealing layer 700 may be increased by the 1b heat dissipation member 610b. Thus, the secondary battery may have improved safety and reliability.

Referring to FIG. 6, the first pattern PA1 and the second pattern PA2 of the heat dissipation members may overlap completely or partially. Accordingly, the heat dissipation characteristics of the accommodation part 110 and the cap part 120 may be similar in the overlapping portion. Therefore, the accommodation part or the cap part may not deform due to a difference in the heat dissipation characteristics of the heat dissipation members.

Referring to FIG. 7, the first pattern PA1 and the second pattern PA2 of the heat dissipation members may not be aligned. In some embodiments, the bonding force of the first layer and the sealing layer may be different in the first pattern PA1 and the second pattern PA2. Since the first pattern PA1 and the second pattern PA2 are not aligned, the overall bonding characteristics of the case and the sealing layer may be made uniform. Accordingly, the accommodation part or the cap part may be prevented from being opened due to a difference in the adhesive force.

FIG. 8 shown various arrangements of the heat dissipation member.

Referring to FIG. 8(a) and 8(b), the heat dissipation member 600 may include a plurality of lines. For example, the heat dissipation member 600 may include a plurality of lines extending in the width direction of the lead 400. Referring to FIG. 8(b), the heat dissipation member 600 may include a plurality of lines extending in the length direction of the lead 400.

Referring to FIG. 8(c), the heat dissipation member 600 may include a plurality of lines extending in the diagonal direction of the lead 400. The lengths of the plurality of lines may be different. For example, the lengths of the plurality of lines may be shorter in an outward direction. Therefore, the heat dissipation member may be disposed in a large number in the central region of the first region and the second region. It is therefore possible to effectively prevent the heat dissipation member from being separated in the central region where the heat source may be concentrated.

Referring to FIG. 8(d), the heat dissipation member 600 may include a plurality of lines that extend in different directions. For example, the first line may extend in the width direction of the lead 400 and the second line may extend in the length direction of the lead 400.

Referring to FIG. 8(e), the heat dissipation member 600 may include a plurality of lines that extend in different directions. For example, the first line may extend in the width direction of the lead 40, the second line may extend in the length direction of the lead 400, and the third line may extend in the diagonal direction of the lead 400.

Referring to FIG. 8(f), the heat dissipation member 600 may include a plurality of lines that extend in the width direction of the lead 400. The lengths of the plurality of lines may be different. For example, the lengths of the plurality of lines may be shorter in an outward direction. Therefore, the heat dissipation member may be disposed in large numbers in the central region of the first region and the second region. It is therefore possible to effectively prevent the heat dissipation member from being separated in the central region where the heat source may be concentrated.

The first heat dissipation member 610 and the second heat dissipation member 620 may be formed in the same shape. In other embodiments, the first heat dissipation member 610 and the second heat dissipation member 620 may be formed in different shapes.

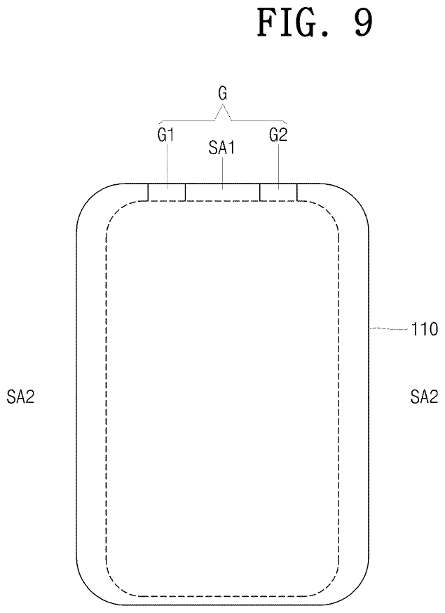

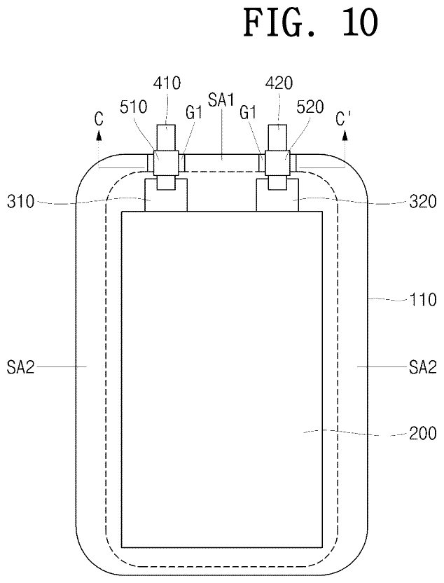

Hereinafter, a secondary battery according to a second embodiment will be described with reference to FIGS. 9 to 12. Commonalities with the embodiment described above will be omitted. In addition, the same drawing reference numerals are given to the same features as those of the embodiment described above.

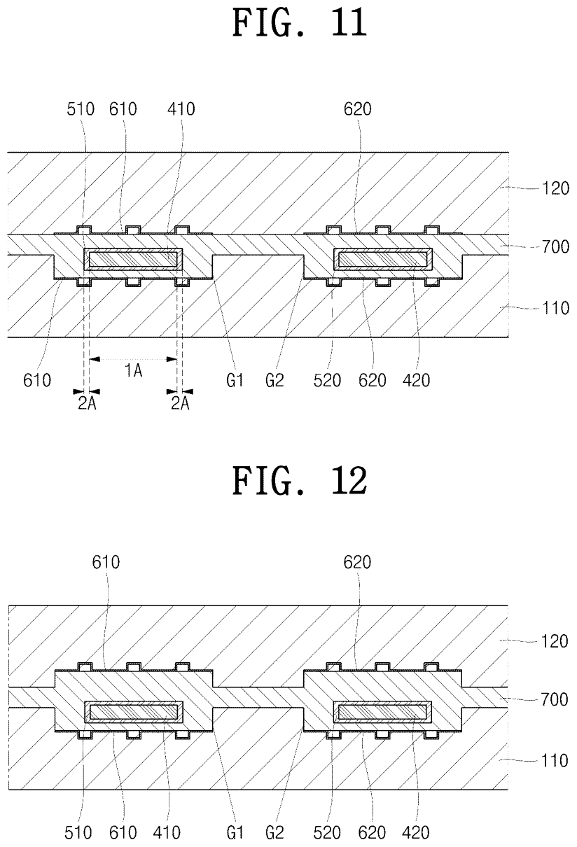

Referring to FIGS. 9 to 12, the case may include a groove. For example, at least one of the accommodation part 110 or the cap portion 120 may include a groove. Referring to FIG. 11, the accommodation part 110 may include a groove. And, referring to FIG. 12, the accommodation part 110 and the cap part 120 may include a groove.

As the accommodation part 110 and/or the cap part 120 may include a groove, the groove may include a first groove G1 and a second groove G2. The first groove G1 may overlap the first lead 410 and the first insulating layer 510. The second groove G2 may overlap the second lead 420 and the second insulating layer 520.

The groove G may be disposed in a set region. In detail, the groove G may be disposed on the first sealing region SA1. The groove G may have a set size. Preferably, the width of the groove (G) may be greater than the width of the lead.

The lead may be guided by the groove. For example, the first lead 410 may be guided by the first groove G1, and the second lead 420 may be guided by the second groove G2. Therefore, the first lead 410 and the second lead 420 may be disposed at set positions. That is, the leads of the plurality of secondary batteries may all be disposed at set positions.

The lead may be accommodated in the groove. For example, the first lead 410 may be disposed in the first groove G1 and the second lead 420 may be disposed in the second groove G2. Therefore, the position of the lead 400 may be fixed by the groove. Thus, when the secondary battery is impacted, the lead may only move in the groove. Therefore, the position of the lead does not changing due to an external impact. And the first lead and the second lead may be prevented from coming into contact due to external impact.

The surface of the sealing layer on the lead may be flat. If the case does not include the groove, the surface of the sealing layer may be convex due to the step of the lead. Accordingly, the secondary battery may have a convex region where the lead is disposed. However, since the accommodation part 110 includes the groove, the surface of the sealing layer may be flat. In detail, since the sealing layer is disposed in the groove, the surface of the accommodation part 110 or the cap part 120 may be not be convex or may be less convex. And, since the lead is disposed in the groove, the step due to the lead is reduced. Thus, the surface of the cap part 120 may be prevented or reduced from becoming convex.

The sealing layer 700 may be disposed in the groove. The area of the sealing layer disposed in the first region 1A and the second region 2A is increased by the groove G. Accordingly, the size of the sealing layer in the region corresponding to the lead 400 and the insulating layer 500 may increase. Accordingly, the bonding force between the sealing layer 700 and the first layer may increase. The safety and reliability of the secondary battery is thereby improved.

The case may include the heat dissipation member. The heat dissipation member may include the first heat dissipation member 610 and the second heat dissipation member 620. The first heat dissipation member 610 may be in the region corresponding to the first groove G1. The first heat dissipation member 610 may be coupled by being sewed to the accommodation part 110 and the cap part 120. The second heat dissipation member 610 may be in a region corresponding to the second groove G2. The second heat dissipation member 620 may be coupled by being sewed to the accommodation part 110 and the cap part 620. The heat dissipation member of the accommodation part may be disposed in the groove.

The heat dissipation member may block heat from being transferred to the sealing member in the first region and the second region. Accordingly, the temperature of the sealing member may not increase in the first region and the second region. This may prevent the sealing layer and the first layer from being separated in the first region and the second region. Therefore, a short circuit of the secondary battery may be prevented, the safety and reliability of the secondary battery may be improved.

The secondary battery described above may form a battery module. Such a battery module may include a plurality of secondary batteries. The plurality of secondary batteries may be connected to each other in series, parallel, or series/parallel by a bus bar.

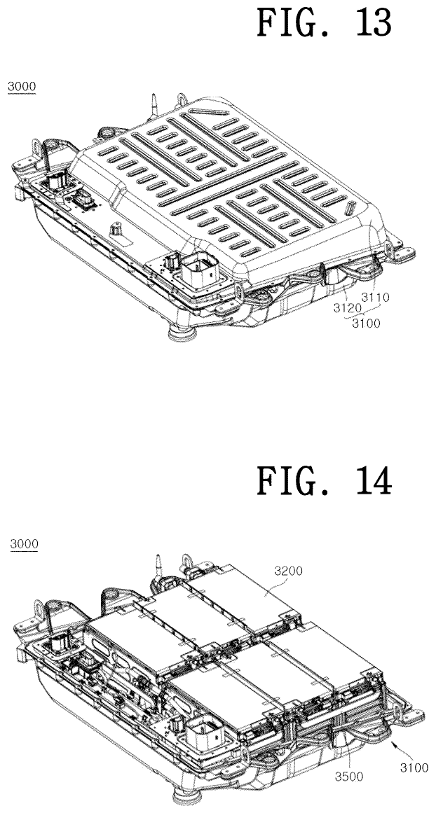

FIGS. 13 and 14 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

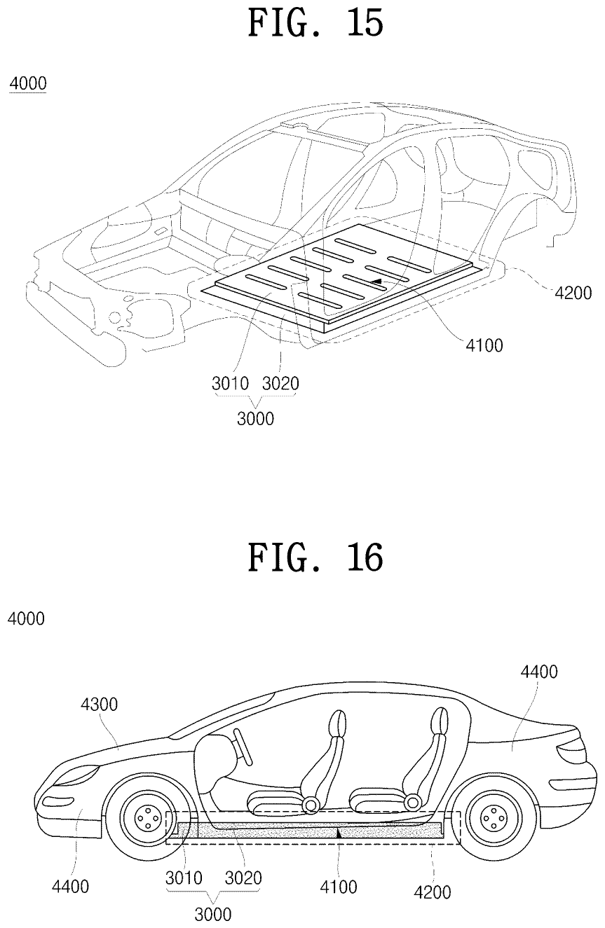

In FIG. 15, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle.

In FIG. 16, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains.

What is claimed is:

1. A secondary battery comprising:
a case comprising an accommodation part and a cap part;
an electrode assembly accommodated in the accommodation part;
an electrode tab connected to the electrode assembly;
a lead connected to the electrode tab;
an insulating layer surrounding the lead; and
a sealing layer sealing the accommodation part and the cap part,
wherein the case comprises at least one layer in contact with the sealing layer, and
wherein at least one of the accommodation part or the cap part comprises a heat dissipation member disposed on a surface of and inside of the at least one layer.

2. The secondary battery as claimed in claim 1, wherein the case comprises a first layer in contact with the sealing layer, a second layer on the first layer, and a third layer on the second layer, and
wherein at least one of the accommodation part or the cap part comprises the heat dissipation member disposed in a surface of and the inside of the first layer.

3. The secondary battery as claimed in claim 2, wherein the case comprises a first sealing region and a second sealing region, and
wherein the lead and the insulating layer are disposed in the first sealing region.

4. The secondary battery as claimed in claim 3, wherein the heat dissipation member is coupled to at least one of the accommodation part or the cap part.

5. The secondary battery as claimed in claim 4, wherein the heat dissipation member is sewed to at least one of the accommodation part or the cap part.

6. The secondary battery as claimed in claim 3, wherein the heat dissipation member comprises a first pattern and a second pattern,
wherein the first pattern is disposed on a surface of the first layer, and
wherein the second pattern is disposed in the first layer.

7. The secondary battery as claimed in claim 6, wherein the first pattern and the second pattern are connected.

8. The secondary battery as claimed in claim 3, wherein the first sealing region comprises a first region, a second region, and a third region,
wherein the lead, the insulating layer, and the sealing layer overlap in the first region,
wherein the insulating layer and the sealing layer overlap in the second region,
wherein the sealing layer is disposed in the third region, and
wherein the heat dissipation member is disposed in the first region, the second region, and the third region.

9. The secondary battery as claimed in claim 8, wherein the heat dissipation member is disposed in a part of the third region.

10. The secondary battery as claimed in claim 1, wherein the heat dissipation member comprises a plurality of linear parts extending in the same direction.

11. The secondary battery as claimed in claim 1, wherein the lengths of the plurality of linear parts decrease in a direction away from a center of the linear parts.

12. The secondary battery as claimed in claim 1, wherein the heat dissipation member comprises a plurality of linear parts extending in a plurality of directions.

13. The secondary battery as claimed in claim 3, wherein the electrode assembly comprises a first electrode, a second electrode, and a separator between the first electrode and the second electrode,
wherein the electrode tab comprises a first electrode tab connected to the first electrode and a second electrode tab connected to the second electrode,
wherein the lead comprises a first lead connected to the first electrode tab and a second lead connected to the second electrode tab, and
wherein the heat dissipation member corresponds to at least one of the first lead and the second lead.

14. The secondary battery as claimed in claim 13, wherein the heat dissipation member comprises a first heat dissipation member corresponding to the first lead and a second heat dissipation member corresponding to the second lead, and
wherein the first heat dissipation member and the second heat dissipation member are different shapes.

15. The secondary battery as claimed in claim 13, wherein at least one of the accommodation part or the cap part comprises a groove,
wherein the groove comprises a first groove and a second groove disposed in the first sealing region,
wherein the first lead is disposed in the first groove, and
wherein the second lead is disposed in the second groove.

16. The secondary battery as claimed in claim 15, wherein a width of the groove is greater than a width of the lead.

17. The secondary battery as claimed in claim 15, wherein the heat dissipation member is disposed in the groove.
